(19) United States
(12) Patent Application Publication
(10) Pub. No.: US 2013/0316864 A1
(43) Pub. Date: Nov. 28, 2013

(54) TRANSMISSION APPARATUS AND TRANSMISSION SHAFT CONTROL MECHANISM

(71) Applicant: HON HAI PRECISION INDUSTRY CO., LTD., New Taipei (TW)

(72) Inventor: HSIU-YU LIN, New Taipei (TW)

(73) Assignee: HON HAI PRECISION INDUSTRY CO., LTD., New Taipei (TW)

(21) Appl. No.: 13/855,860

(22) Filed: Apr. 3, 2013

(30) Foreign Application Priority Data
May 25, 2012 (TW) 101118814

(51) Int. Cl. F16H 35/10

(52) U.S. Cl. CPC F16H 35/10
USPC 474/198

(57) ABSTRACT

A transmission shaft control mechanism is provided for a transmission apparatus. The transmission shaft control mechanism includes a mounting member, stationary member, and a braking member. The mounting member is secured to a transmission shaft. The stationary member is secured to a supporting plate. The braking member surrounds the transmission shaft and is located between the mounting member and the stationary member. The braking member is able to move axially along the transmission shaft. When the braking member moves to a position where the braking member is in contact with the stationary member, a friction force is produced between the braking member and the stationary member thereby smoothening the rotation of the transmission shaft.

### REFERENCE TO RELATED APPLICATIONS

This application claims all benefits accruing under 35 U.S.C. §119 from Taiwan Patent Application No. 101118814, filed on May 25, 2012 in the Taiwan

Intellectual Property Office, the contents of the Taiwan Application are hereby incorporated by reference.

### BACKGROUND

1. Technical Field

The present disclosure generally relates to a power transmission system, and particularly relates to a transmission apparatus equipped with a transmission shaft control mechanism.

2. Description of Related Art

In a power transmission system of an automation equipment, a transmission shaft is provided for transmitting power from a power source, such as a motor, to other apparatuses. However, a sudden acceleration of the transmission shaft in an idle state may result in damages to the power transmission system due to insufficient fuel.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a transmission shaft control apparatus in accordance with an embodiment.

FIG. 2 is an isometric view of a transmission apparatus equipped with the transmission shaft control apparatus of FIG. 1.

FIG. 3 is similar to FIG. 2, but viewed from a different aspect.

FIG. 4 is similar to FIG. 3, but showing a braking member in contact with a stationary member.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

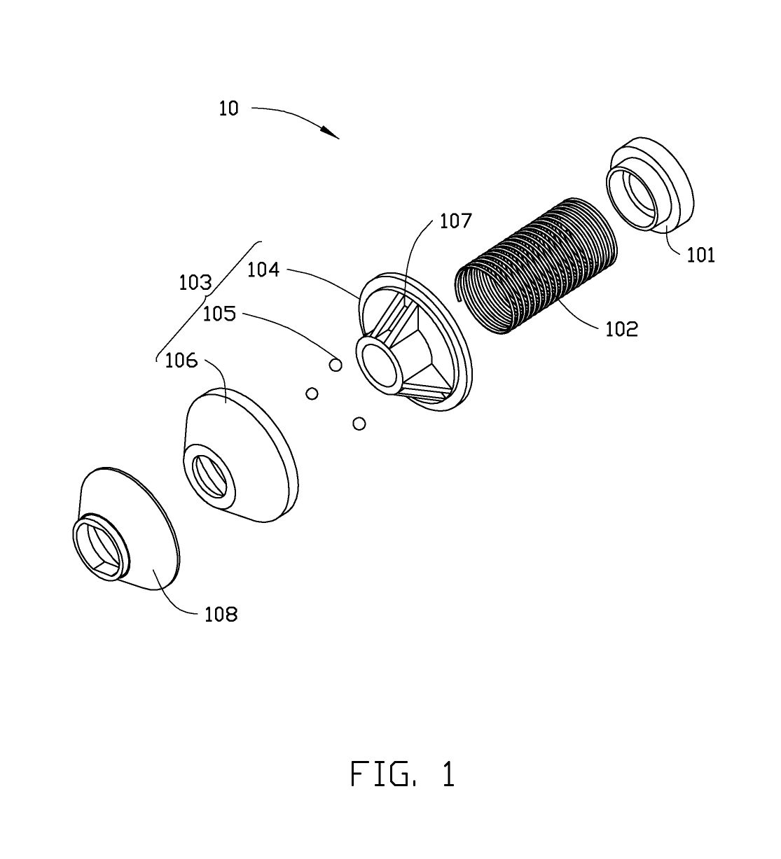

FIG. 1 shows a transmission shaft control mechanism 10 in accordance with an embodiment. The transmission shaft control mechanism 10 includes a mounting member 101, a resilient member 102, a braking member 103, and a stationary member 108. A through hole is defined in the center of each of the mounting member 101, the resilient member 102, and the stationary member 108.

The resilient member 102 is located between the mounting member 101 and the braking member 103. In one embodiment, the resilient member 102 is a compression spring.

The braking member 103 includes a base 104, a cover 106, and a plurality of balls 105. A through hole is defined in the center of each of the base 104 and the cover 106.

The base 104 defines a plurality of chambers 107. When the cover 106 is placed on and engaged with the base 104, the cover 106 together with the plurality of chambers 107 forms a plurality of closed spaces. Each of the plurality of closed spaces can accommodate one of the plurality of ball 105. When a ball 105 is received in a closed space, the ball 105 is free to move in the closed space. In one embodiment, the ball 105 is made of metal.

The cover 106 and the stationary member 108 are disc-like. When an outer surface of the cover 106 is in contact with an inner surface of the stationary member 108, a friction force can be produced between the cover 106 and the stationary member 108.

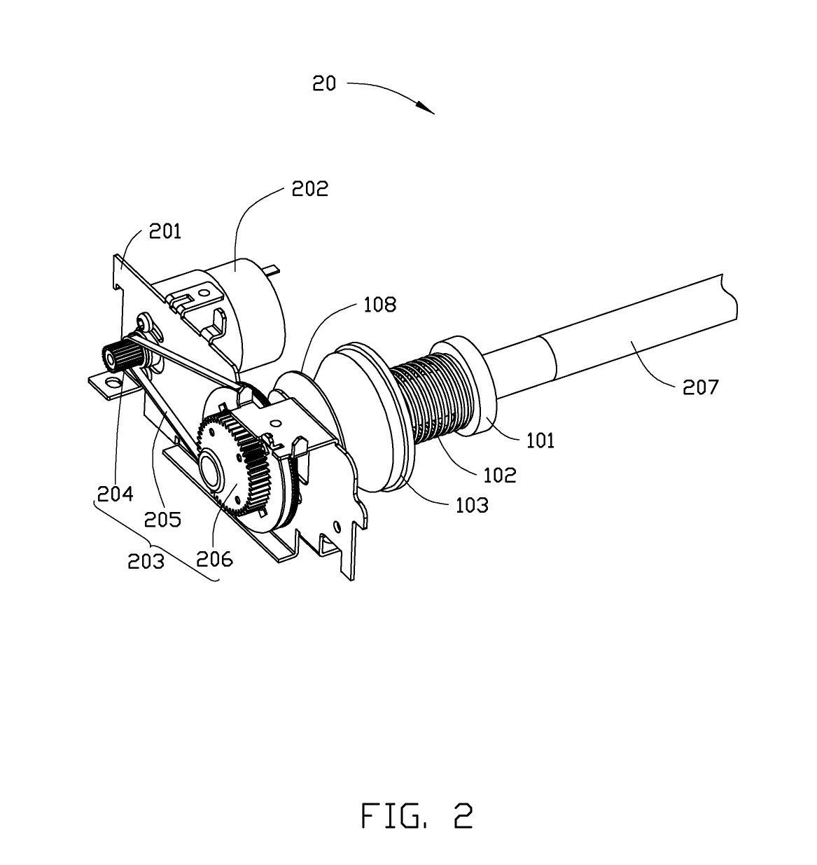

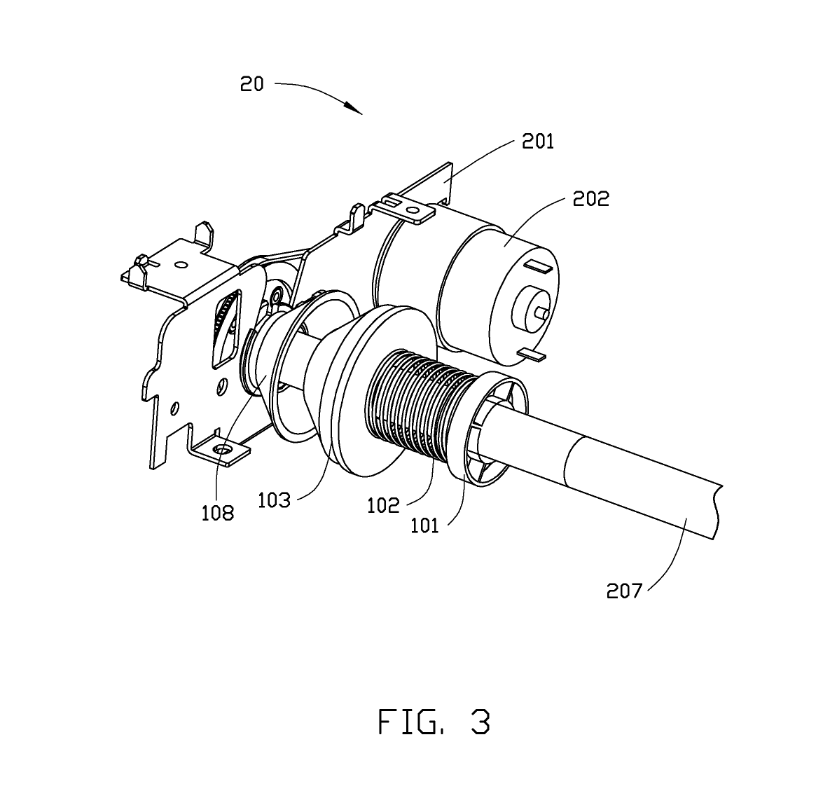

FIGS. 2 and 3 shows a transmission apparatus 20 equipped with the transmission shaft control mechanism 10. The transmission apparatus 20 includes a supporting plate 201, a motor 202, a belt wheel assembly 203, and a transmission shaft 207. The motor 202 and the belt wheel assembly 203 are mounted to the supporting plate 201.

The belt wheel assembly 203 includes a driving wheel 204, a driven wheel 206 and a belt 205 rotating around the driving wheel 204 and the driven wheel 206. The driving wheel 204 is connected to the motor 202 and may be driven to rotate by the motor 202. The driven wheel 206 may be rotated along with the driving wheel 204.

The transmission shaft 207 is inserted through the central through hole of each of the mounting member 101, the resilient member 102, the braking member 103, and the stationary member 108 successively. An end of the transmission shaft 207 is connected to the driven wheel 206. Thus, the transmission shaft 207 may be driven to rotate by the driven wheel 206.

The stationary member 108 is secured to the supporting plate 201. The aperture of its central through hole is larger than the diameter of the transmission shaft 207, so that the stationary member 108 is not in contact with the transmission shaft 207.

The mounting member 101 is firmly secured to the transmission shaft 207 and will not move relative to the transmission shaft 207.

The cover 106 is placed on and firmly attached to the base 104. The cover 106 together with the plurality of chambers 107 forms a plurality of closed spaces. Each of the plurality of closed spaces accommodates a ball 105, which is free to move inside the closed space.

The braking member 103 is located between the stationary member 108 and the mounting member 101. The resilient member 102 is located between the braking member 103 and the mounting member 101. One end of the resilient member 102 abuts the mounting member 101 and the other end of the resilient member 102 abuts the base 104 of the braking member 103. The resilient member 102 provides an elastic force to push the braking member 103 to move towards the stationary member 108.

The aperture of the braking member 103 is larger than the diameter of the transmission shaft 207, so that the braking member 103 is movable along the transmission shaft 207. When the braking member 103 rotates about the transmission shaft 207, the plurality of balls 105 residing in the braking member 103 are flung out by centrifugal force to push the braking member 103 to move away from the stationary member 108 and towards the mounting member 101.

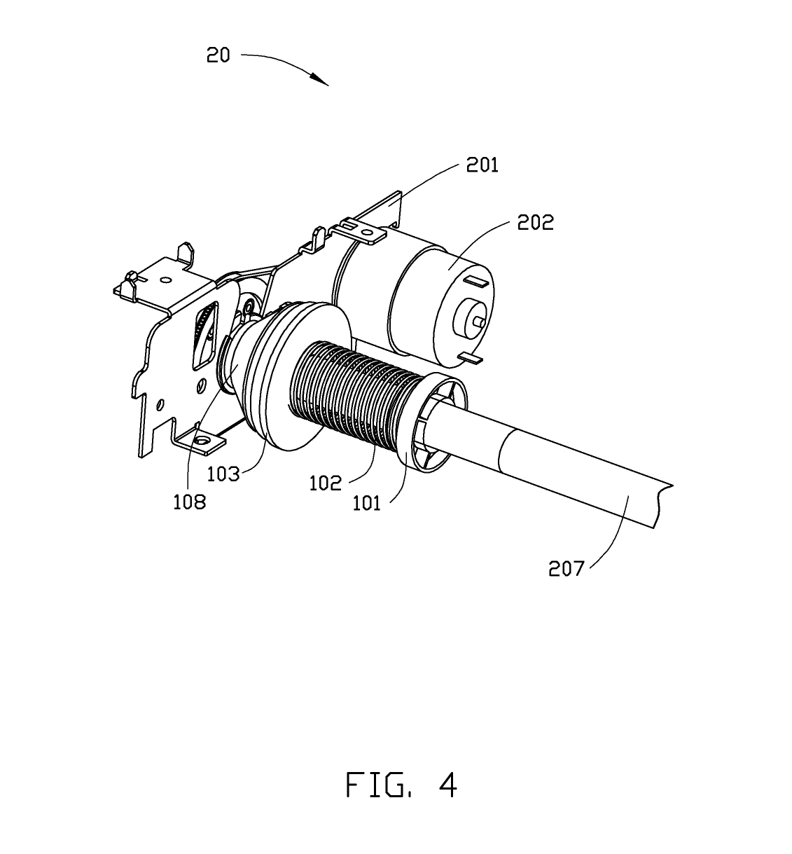

Referring to FIG. 4, when the braking member 103 rotates at a rotation speed low enough to make the centrifugal force produced by the plurality of balls 105 smaller than the elastic force produced by the resilient member 102, the braking member 103 moves away from the mounting member 101 and towards the stationary member 108. The braking member 103 is thus in surface contact with the stationary member 108 and a friction force is accordingly produced between the braking member 103 and the stationary member 108, which smoothens and stabilizes the rotation of the transmission shaft 207.

Referring to FIG. 3, when the braking member 103 rotates at a rotation speed high enough to make the centrifugal force produced by the plurality of balls 105 greater than the elastic force produced by the resilient member 102, the braking member 103 moves away from the stationary member 108 and towards the mounting member 101. The braking member 103 is thus no longer in contact with the stationary member 108 (as shown in FIG. 4) and the friction force produced between the braking member 103 and the stationary member 108 accordingly disappears.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A transmission apparatus, comprising:
a supporting plate;
a motor mounted to the supporting plate;
a transmission shaft;
a belt wheel assembly configured to transmit power from the motor to the transmission shaft; and
a transmission shaft control mechanism comprising:
a mounting member secured to the transmission shaft;
a stationary member secured to the supporting plate; and
a braking member surrounding the transmission shaft and located between the mounting member and the stationary member, wherein the braking member is configured to move axially along the transmission shaft, and when the braking member is in contact with the stationary member, a friction force is produced between the braking member and the stationary member thereby smoothening the rotation of the transmission shaft.

2. The transmission apparatus of claim 1, wherein the transmission shaft control mechanism further comprises a resilient member surrounding the transmission shaft and located between the braking member and the mounting member, the resilient member comprising a first end abutting the mounting member and a second end abutting the base, thereby providing an elastic force to push the braking member away from the mounting member and towards the stationary member.

3. The transmission apparatus of claim 2, wherein the resilient member is a compression spring with a central hole, the transmission shaft is received in the central hole.

4. The transmission apparatus of claim 2, wherein the braking member comprises a base and a cover placed on and attached to the base, a through hole is define in the center of each of the base and the cover, and the transmission shaft is inserted through the through hole of each of the base and the cover.

5. The transmission apparatus of claim 4, wherein the braking member further comprises a plurality of balls, the braking member defines a plurality of closed space, and each of the plurality of closed space accommodates one of the plurality of balls.

6. The transmission apparatus of claim 5, wherein the base defines a plurality of chambers, and the cover together with plurality of chambers forms the a plurality of closed spaces.

7. The transmission apparatus of claim 5, wherein the plurality of balls are made of metal.

8. The transmission apparatus of claim 5, wherein the cover and the stationary member are disc-like, and when an outer surface of the cover is in contact with an inner surface of the stationary member, the friction force is produced between the outer surface of cover and the inner surface of the stationary member

9. The transmission apparatus of claim 5, wherein when the braking member rotates about a central axis of the transmission shaft, the plurality of balls residing in the braking member produce a centrifugal force to push the braking member to move away from the stationary member and towards the mounting member.

10. The transmission apparatus of claim 5, wherein when the braking member rotates at a certain rotation speed, the centrifugal force produced by the plurality of balls is smaller than the elastic force produced by the resilient member such that resilient member drives the braking member to contact the stationary member.

11. A transmission shaft control mechanism, comprising:
a mounting member secured to a transmission shaft;
a stationary member secured to a supporting plate; and
a braking member surrounding the transmission shaft and located between the mounting member and the stationary member, wherein the braking member is adapted to move axially along the transmission shaft, and when the braking member is in contact with the stationary member, a friction force is produced between the braking member and the stationary member thereby smoothening the rotation of the transmission shaft.

12. The transmission shaft control mechanism of claim 11, wherein the transmission shaft control mechanism further comprises a resilient member surrounding the transmission shaft and located between the braking member and the mounting member, the resilient member comprising a first end abutting the mounting member and a second end abutting the base, thereby providing an elastic force to push the braking member away from the mounting member and towards the stationary member.

13. The transmission shaft control mechanism of claim 12, wherein the resilient member is a compression spring with a central hole for receiving the transmission shaft.

14. The transmission shaft control mechanism of claim 12, wherein the braking member comprises a base and a cover placed on and attached to the base, a through hole is define in the center of each of the base and the cover, and the transmission shaft is inserted through the through hole of each of the base and the cover.

15. The transmission shaft control mechanism of claim 14, wherein the braking member further comprises a plurality of balls, the braking member defines a plurality of closed space, and each of the plurality of closed space accommodates one of the plurality of balls.

16. The transmission shaft control mechanism of claim 15, wherein the base defines a plurality of chambers, and the cover together with plurality of chambers forms the a plurality of closed spaces.

17. The transmission shaft control mechanism of claim 15, wherein the plurality of balls is made of metal.

18. The transmission shaft control mechanism of claim 15, wherein the cover and the stationary member are disc-like, and when an outer surface of the cover is in contact with an inner surface of the stationary member, the friction force is produced between the outer surface of cover and the inner surface of the stationary member

19. The transmission shaft control mechanism of claim 15, wherein when the braking member rotates about a central axis of the transmission shaft, the plurality of balls residing in the braking member is adapted to produce a centrifugal force to push the braking member to move away from the stationary member and towards the mounting member.

20. The transmission shaft control mechanism of claim 19, wherein when the braking member rotates at a certain rotation speed, the centrifugal force produced by the plurality of balls is smaller than the elastic force produced by the resilient member such that resilient member drives the braking member to contact the stationary member.
